(19) United States
(12) Patent Application Publication
(10) Pub. No.: US 2016/0170466 A1
(43) Pub. Date: Jun. 16, 2016

(54) POWER SAVING MULTI-WIDTH PROCESSOR CORE

(71) Applicant: Jefferson H. HOPKINS, Orrington, ME (US)

(72) Inventor: Jefferson H. HOPKINS, Orrington, ME (US)

(21) Appl. No.: 14/570,647

(22) Filed: Dec. 15, 2014

(51) Int. Cl. G06F 1/32; G06F 13/24; G06F 9/30

(52) U.S. Cl. CPC G06F 1/324; G06F 1/3287; G06F 9/30043; G06F 13/24

(57) ABSTRACT

A single core, multi-width merged architecture processor using industry standard instructions to provide power savings and higher performance at lower clock rates. The processor core has two separate decode blocks that share internal memory work space, memory management, and I/O processing. In normal functional mode the processor executes instructions using 8 bit wide data and instructions. In 8 bit mode the clock tree to the 32 bit functionality is held low to allow for low power operation. When additional processing power is required, the 32 bit decode blocks are enabled and the 8 bit functionality is disabled. The internal work context is shared between the two modes, so the same memory and registers are manipulated in either 8 bit or 32 bit modes. In a particular embodiment, the multi-width, merged architecture core is an embedded core using an industry standard, 8 bit register and interrupt architecture with a special 32 bit mode, providing an industry standard 16 bit instruction set with 32 bit data and register accesses to process the aforementioned 8 bit register architecture.

### FIELD OF THE INVENTION

The present invention relates to embedded processor cores and is particularly concerned with power savings at lower clock rates by implementing multiple width, merged architecture processing units.

### BACKGROUND OF THE INVENTION

Most modern electronic devices from cell phones, to DVD players, to high-speed computers, rely extensively on embedded processor cores to provide the flexibility and function for a continually complex environment. As functional complexity increases the embedded cores are required to provide increased processing power. Traditionally this required increase is accomplished through either creating a wider processor core that processes more data per instruction, increasing the clock rate to process more instructions per unit of time, or a combination of both techniques.

Power dissipation for embedded processors is important, especially for battery powered devices like cell phones and tablet computers. Every time a switching element within a design switches, power is dissipated. Designs that switch faster, with a higher clock rate, dissipate more power per unit of time. Designs that switch more elements every clock cycle dissipate more power per clock cycle. Therefore, processor internal power dissipation is a function of the number of switching elements (Clock Fan Out) and the number of clock cycles per unit of time (Clock Frequency). When processing power is increased, by increasing the clock frequency, the internal power dissipation is equally increased due to the increased number of switches per unit of time. When processing power is increased, by implementing a wider core or more switching elements per clock, the internal power dissipation is equally increased due to the increased clock fan out. Power is dissipated through the clock fan out tree even when the switching element does not switch.

Traditional power saving processor designs have reduced power by turning off the clock until an interrupt event happens that requires the processor to process some data. Many times this entails just a register check and does not require the full processing capability of the processor, however, the full clock fan out must be switched, which uses the full power requirement of the processor.

A second solution is to completely shut off the clock fan out tree and the PLL (Phase Locked Loop) that drives it. This typically requires a significant amount of time to restart the clock and is not conducive to multiple starts and stops in a short period of time.

There is thus demonstrated a need for an improved embedded processor architecture.

It is therefore an object of the present invention to provide an improved embedded processor architecture.

Other objects and advantages of the present invention will become obvious to the reader and it is intended that these objects and advantages are within the scope of the present invention. To the accomplishment of the above and related objects, this invention may be embodied in the form illustrated in the accompanying drawings. Attention is called to the fact, however, that the drawings are illustrative only, and that changes may be made in the specific construction illustrated and described within the scope of this disclosure.

### SUMMARY OF THE INVENTION

In accordance with an aspect of the present invention there is provided a multiple width, merged architecture, embedded processor core which is compatible with multiple sets of industry standard instructions. The core has two distinct modes within one load/store context. A reduced width mode is used for low power “book keeping” instructions. A wider, faster, and higher power mode is used for required processing.

### BRIEF DESCRIPTION OF THE DRAWINGS

FIG. 1 is a schematic drawing of internal working memory.

FIG. 2 is a schematic drawing of lode/store memory.

FIG. 3 is a schematic drawing of clock gating for different modes.

FIG. 4 is a schematic drawing of the internal architecture and clock domains.

### DETAILED DESCRIPTION OF THE PREFERRED EMBODIMENT

The multi-width embedded core is a synthesizable core using an industry standard instruction set and architecture. The architecture is a traditional load/store architecture. The memory containing the instructions codes and the data is tightly coupled to the processor and is accessed on separate, 32 bit buses.

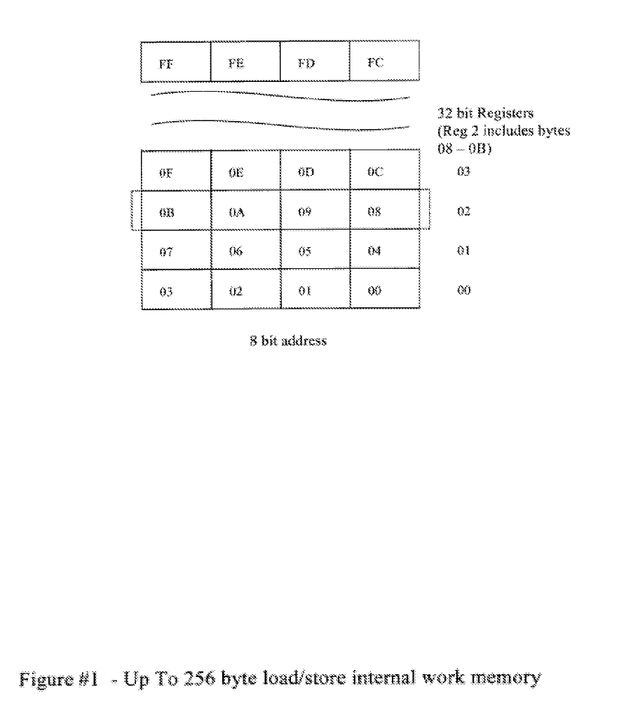

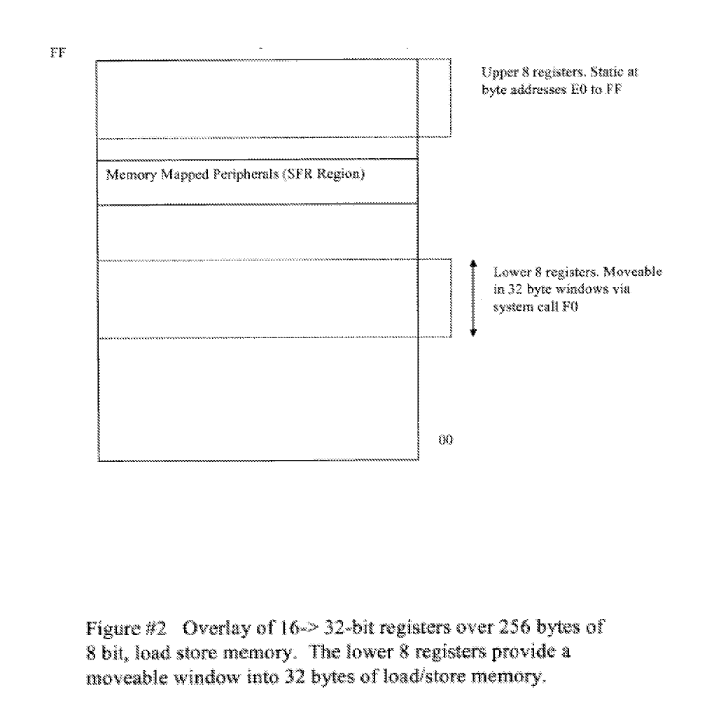

Referring to FIG. 1 there is illustrated the merged internal working random access memory (RAM). The internal working RAM or register area contains up to 256 bytes of storage space. The internal registers, I/O ports, and stack are memory mapped onto these 256 bytes. All data processing is performed within the 256 bytes. When in 8 bit mode, this memory is accessed by direct address within the execute unit. The 32 bit load/store area is accessed through a set of 16 registers. Sixteen 32 bit (4 byte) registers can only map 64 bytes of internal space. In order to access the full 256 bytes of load/store space the lower 8 registers can be moved, or windowed, across the full 256 byte space. This moveable register window is shown in FIG. 2.

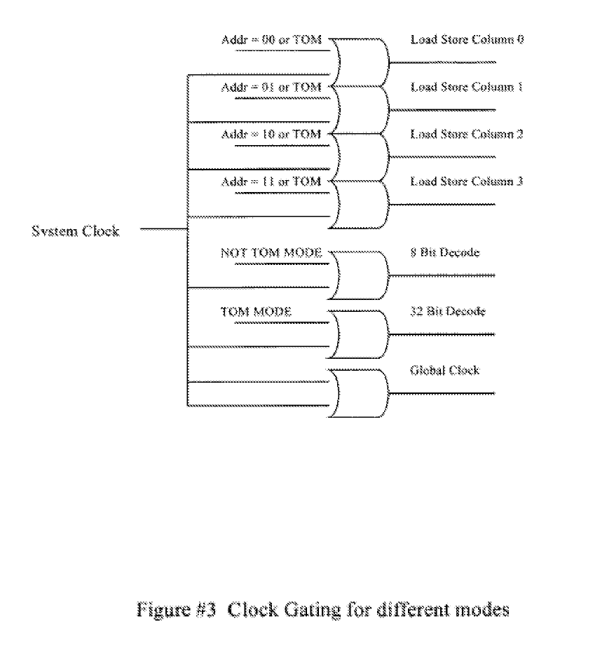

Referring to FIG. 3 there is illustrated the clock gating structure. The bulk of the internal flip flops, or memory, is found in the Load/Store block. When in 8 bit mode only one of the four column clocks pulses at a time, dividing the clock tree power dissipation by four. When in 32 bit mode all column clocks pulse at once enabling 32 bit processing.

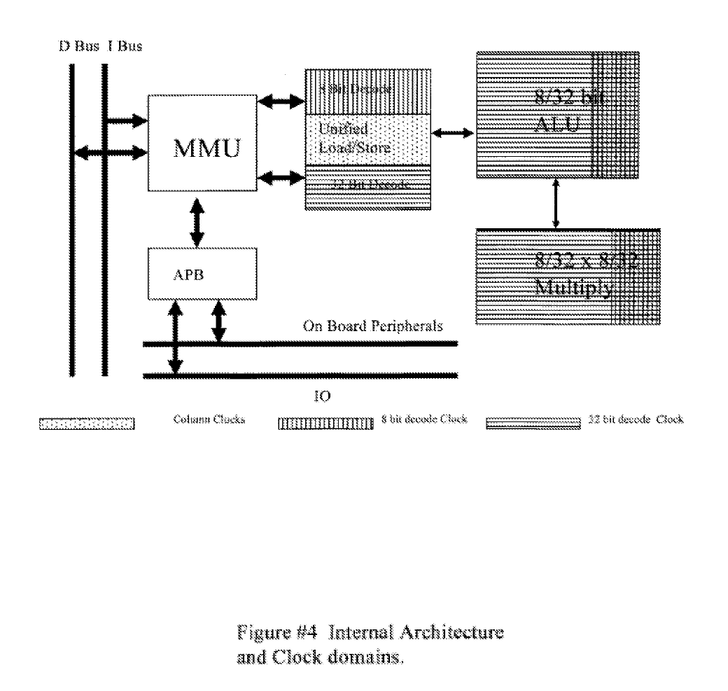

Referring to FIG. 4 there is illustrated the merged architecture. The processor has two modes within the merged architecture, a 32 bit processing mode and an 8 bit processing mode. When the processor is reset it will run in 8 bit mode. In 8 bit mode industry standard instructions can be 8, 16, or 24 bits wide; however, only 8 bits of working RAM and/or Arithmetic Logic Unit (ALU) are manipulated at a time. Instructions are loaded from the instruction bus 32 bits at a time. The 8 bit mode is the normal lower power mode. When running in 8 bit mode, the clock fan out to the 32 bit decode and execute blocks, as well as the upper 24 bits in the ALU, are turned off to reduce the power. The internal working memory is divided into four 8 bit wide sections. Only 8 bits of memory are accessed at a time. Most of the book keeping and status updating is done in this mode.

When additional processing is needed, 32 bit mode can be entered by either calling a 32 bit mode function as defined in the interrupt table, or by setting the 32 bit mode bit which causes the processor to jump to the code address location defined by the DPTR register in the processor register space.

32 bit mode is the higher power mode. 32 bit instructions are compatible with an industry standard 16 bit instruction set for 32 bit processors. In this mode all instructions are 16 bits wide and 32 bits of working memory or ALU are accessed at a time. The internal working memory is directly available to the 32 bit mode instructions by overlapping a moveable, lower 8 bit register window on top of the working memory. This memory window allows the 32 bit register window to access all the 256 byte working memory. This mode accesses the internal working memory, four 8 bit bytes at a time.

When the 32 bit processing has completed, the processor is returned to 8 bit mode by the software. The software can return to 8 bit mode in one of two ways. If 32 bit mode was entered through a hardware or software interrupt, a “return from interrupt” instruction will disable 32 bit mode and continue processing from the vector table, then returning to the calling location. If 32 bit mode was entered by setting the 32 bit mode bit in the status register, software will clear the 32 bit mode bit. This will allow the processor to continue processing 8 bit instructions at the 8 bit program counter location.

Software program development for the core requires two industry standard compilers. The software is developed in an industry standard high level language like C++. At compile time the source code is pre-processed into two separate groups, 8 bit and 32 bit as defined in PRAGMA's in the code. Each set of high level code is routed to the appropriate compiler. At link time the two sets of code objects are linked to different locations within the instruction memory. The different sets of code are then used as described above.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

What is claimed:

1. A variable width, merged architecture processor for increased functionality and power savings comprising:
a single load/store architecture industry standard processor core having a first decode unit and a second decode unit, with each decode unit having width,
wherein the second decode unit is wider than the first decode unit,
with each decode unit having access to a single, internal, load/store memory work area.

2. The variable width, merged architecture processor of claim 1 where the width of the first decode unit is 8 bits and the width of the second decode unit is 32 bits.

3. A method of sharing merged architecture access to an internal processing memory work area through overlaid windowing of register sets on the single internal processing memory work area, said method comprising the steps of:
A. obtain an internal memory block, accessed via address locations in a first mode and via register accesses in a second mode;
B. provide a movable window by the register accesses on the internal processing memory work area to allow complete memory access.

4. The method of claim 3 wherein the first mode is an 8 bit mode and the second mode is a 32 bit mode, wherein the internal processing memory work area is accessed by address in the first mode and accessed by a register window in the second mode.

5. A method of switching between a first processor mode and a second processor mode, whereby the first processor mode is high power/high speed and the second processor mode is low power/low speed, said method comprising executing one of the following steps:
A. switch to first processor mode by transferring to high speed interrupt service routines via interrupt vectors and switch to second processor mode via a return from interrupt command;
B. switch to first processor mode by transferring to high speed routines by setting a high speed control bit that automatically transfers processing to a high speed routine indexed by a pointer register and switch to second processor mode by clearing the high speed control bit;
C. switch to first processor mode at power up if indicated by a first code byte and remaining in first processor mode;
D. switch to second processor mode at power up if indicated by a first code byte and remaining in second processor mode.
